(19) United States
(12) Patent Application Publication
(10) Pub. No.: US 2018/0332007 A1
(43) Pub. Date: Nov. 15, 2018

(54) System and Method for Data and Communications Security

(71) Applicant: DARQ, LLC, Pine, CO (US)

(72) Inventor: Gary Leland Bryan, Pine, CO (US)

(21) Appl. No.: 15/977,262

(22) Filed: May 11, 2018

Related U.S. Application Data
(60) Provisional application No. 62/505,399, filed on May 12, 2017.

(51) Int. Cl. H04L 29/06; G06F 17/30; G06F 9/451; H04L 12/46; H04L 12/24

(52) U.S. Cl. CPC H04L 63/0272; G06F 17/30575; H04L 63/08; H04L 12/4641; H04L 41/22; G06F 9/451

(57) ABSTRACT

A system and method is provided for secure data and communications. The system including a processor, a data storage device and a first component configured to create a virtual private network (VPN) connection with one or more other devices. The system further including a second component configured to synchronize data stored on the data storage device with data stored remotely, and a graphical user interface (GUI) in communication with the data storage device, the first component, and the second component, the GUI configured, responsive to user input or instructions stored on the storage device, to instruct the first component to create a virtual private network connection with one or more other devices, and further configured to instruct the second component to synchronize data stored on the data storage device with data stored remotely.

### CROSS-REFERENCE TO RELATED APPLICATIONS

This application claims priority to U.S. Provisional Application No. 62/505,399 filed May 12, 2017 by Gary Leland Bryan entitled, “System and Method for Data and Communications Security”, which is incorporated by reference herein as if reproduced in its entirety.

### BACKGROUND

As telecommunications technology has evolved, more advanced network access equipment has been introduced. Most modern systems such as mobile telephones and devices, tablet computers, handheld or laptop computers, smart devices and other similar devices, which may be referred to as “user equipment” (UE) herein, have telecommunications capabilities. The term “UE” may also refer to devices that have similar capabilities but that are not transportable, such as fixed line telephones, desktop computers, or set-top boxes. There is an ongoing need for improvements in securing communications and data by and between such systems.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an illustration of a security architecture according to an embodiment of the disclosure.

FIG. 2 is a flow chart of a method for securing communications and data according to an embodiment of the disclosure.

FIG. 3 is an illustration of a system for securing communications and data according to an embodiment of the disclosure.

FIG. 4 is a block diagram showing of an example user equipment capable of being used with the systems and methods in the embodiments described herein.

FIG. 5 illustrates an example of a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Most cyber security products are developed to protect large data centers housing massive databases of information. While there are security systems designed for individual users, many of these products address only a single issue and require a high degree of technical skill to implement and effectively use. Most cyber security products and services designed for individuals are reactive solutions that help users to recover after their security has been breached. The result is that the vast majority of internet users must rely on third parties to provide secure environments to house their personal data and to help them recover it in the event of a data breach.

The present disclosure provides a myriad of innovative security focused systems and methods. For example, the present disclosure provides an improved system, which may be referred to herein as a darQframe or darQframe model or more generally as an architecture, that establishes a development environment for rapidly building and deploying personal cyber security products and services. By combining elements that are useful for promoting security, the present disclosure provides the elements, for example, for user authentication, data and communications encryption, fault tolerant backup, synchronization of user and configuration data, and other security functionality. Using the present system enables cyber security applications to be deployed directly to end users, allowing the end users more control over their own data privacy and security concerns.

The various systems and methods or operations described herein may be implemented by various known network elements and UEs communicating via networks. The networks may include, but are not limited to, local area networks (LANs), wide area networks (WANs), and the internet via communication systems such as wired networks, wireless fidelity (Wi-Fi), cellular networks, such as code divisional multiple access (CDMA) and global system for mobile communications (GSM), optical networks, and others.

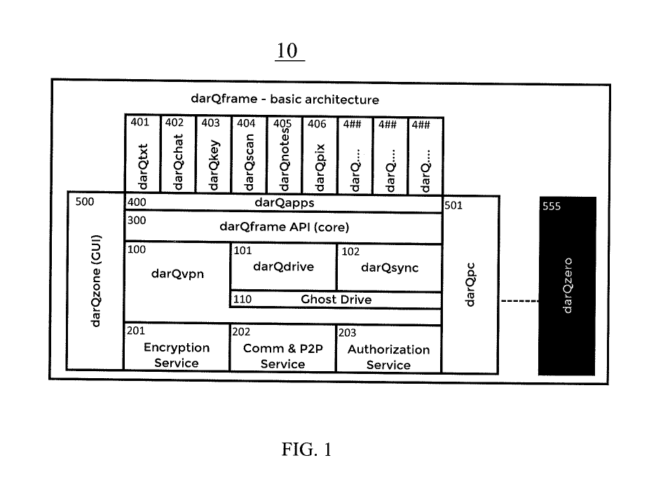

FIG. 1 illustrates an embodiment of the present disclosure of an architecture 10 that may be implemented on the network elements, UEs, and networks discuss herein. The architecture 10 may be referred to in some instances as darQframe. The architecture 10 includes a darQvpn 100, darQdrive 101, darQsync 102, Ghost Drive 110, Encryption Service 201, Communications and P2P (Peer-to-Peer) Service 202, Authorization Service 203, darQframe application programming interface (API) 300, darQapps 400, darQzone 500, darQpc 501, and darQzero 555. The architecture 10 provides a framework to rapidly prototype, build, and deploy cyber security applications. Typical systems offer products that address a single issue. Some vendors offer multiple products, however the individual products do not readily integrate with one another. The architecture 10 is a development platform that allows for interoperability between the applications and services. The architecture 10 may be, in some embodiments, more fault tolerant across applications. While some systems are not fault tolerant and can only be recovered by re-installation, applications built on a common framework, such as the architecture 10 may constitute applications and configuration data that can be managed similarly and recovered by defined protocols, as will be understood by one skilled in the art. The architecture 10 may be considered, in some embodiments, a system that effectively builds a digital security wall between the user's public persona and private data. For example, by separating the user's identity from a specific device, private data and configuration data can be restored to a new device more readily. Furthermore, the architecture 10 provides a framework so that data on a lost, missing, or damaged device is protected through encryption so sensitive data is never exposed to intruders that might breach the system.

The darQvpn 100 is virtual private network (VPN) element of the architecture 10. The darQvpn 100 extends a private network across a public network, and enables users to send and receive data across shared or public networks as if their computing devices were directly connected to the private network. The darQvpn 100 employs encryption to provide secure access to a remote computer over the internet or other networks, as described herein. The darQvpn 100 may be constructed, in some embodiments, using open source OpenVPN Access Server. Other tools may be used as would be understood by one skilled in the art. For example, many commercially available VPN software products on the market today are built using OpenVPN Access Server code base. For this reason, developing the darQvpn 100 using OpenVPN Access Server VPN may be preferred, in some embodiments, because of its stability, community support, and proven robustness. Furthermore, OpenVPN Access Server provides full access to the source code which allows more flexibility for development of other modules to “plugin” and provide other services in order to meet the specialized needs of numerous security solutions and products, which are discussed in greater detail herein.

The darQdrive 101 provides encrypted file storage. The darQdrive 101 may provide for encrypted data storage, for example, on the user equipment, in some embodiments, while in other embodiments the data may be stored remotely on one or more servers located on the internet, such as cloud storage devices, or on other devices, such as edge devices. While in yet other embodiments, the encrypted data storage may be stored on both the user equipment and on remote servers or devices and periodically synchronized, as will be discussed in greater detail herein.

The darQdrive 101 provides storage of files and configuration information that is encrypted and accessible only through an application program interface (API), such as the darQframe API 300 discussed in greater detail herein. The data files may be user data, such as photos, videos, personal data, and the like. The configuration information may include, but is not limited to, configuration information related to user preferences, device settings, application information and related data settings and so on, related to the user's user equipment and operation thereof. In some embodiments, an optional application may be provided to allow users to manage their storage space and select individual files so that the darQdrive 101 may be implemented as a server in the architecture 10 for users with greater file storage needs

The darQsync 102 provides data synchronization functionality to enable synchronization of the darQdrive 101, for example, when the data on the darQdrive 101 is located on the user equipment with encrypted storage, or for example, data stored on network equipment, such as cloud storage devices, network servers, and so on. The remotely stored data may be hosted and accessible via the darQvpn 100. By synchronizing the encrypted darQdrive 101 to the cloud, for example, data integrity is preserved and the data remains available for recovery by the user via user equipment or a new user device, for example when a device becomes inoperable or the user upgrades to new device. The darQsync 102 may also be used to synchronize data between applications for interoperability, such as darQapps 400, which will be discussed in greater detail herein.

The Ghost Drive 110 combines the functionality of both the darQdrive 101 and darQsync 102 to implement a virtual encrypted drive. The Ghost Drive 110 may be a separate drive system located in a different, or in some cases, the same location as the darQdrive 101 synchronized backup data. The Ghost Drive 110 remains encrypted and hidden until called upon for a drive function, such as a read or write operation, at which time the drive image is decrypted, mounted, and accessible only by the user of the Ghost Drive 110 via the darQvpn 100. When the functionality of the Ghost Drive 110 is no longer needed or times out based on set parameters, the Ghost Drive 110 synchronizes with the darQdrive 101 and/or other data stores, such as that stored on the user equipment or elsewhere. The synchronization and data to be backed-up may be user specified or defined. Changes to the data are then synchronized and stored to the cloud storage device or other location where the Ghost Drive 110 storage is located. The Ghost Drive 110 then unmounts and reverts to the encrypted state. This allows the drive to “exist” or be visible or accessible only when accessed by the specific user and otherwise remains offline and “hidden” when not being accessed, which in some embodiments may constitute a significant or large majority of the time. The Ghost Drive 110 differs from typical web storage systems and virtual drive utilities in that it is cryptographically tethered to an encrypted mirror drive located in an encrypted cloud, for example, on servers or other network elements. The architecture 10 manages all data synchronization and the drive will only mount once appropriately authenticated by the user. In contrast, typical cloud storage systems remain online, in a mounted state, a majority of the time making them more susceptible to intrusion attempts.

The Encryption Service 201 provides functionality to encrypt data including, but not limited to, to create virtual encrypted disks, to create virtual encrypted disks within a file, and/or to encrypt a full disk partition. The Encryption Service 201 may be built using open source VeraCrypt for on-the-fly encryption (OTFE). Other methods of developing the Encryption Service 201 will readily suggest themselves to one of ordinary skill in the art and are all within the spirit and scope of the present disclosure. The Encryption Service 201 may support numerous ciphers including, but not limited to, advanced encryption standard (AES), Serpent, Twofish, Camellia, and Kuznyechik. Cyrptographic hash functions that may be available include, but are not limited to, RIPEMD-160, SHA-356, SHA-512, Streebog, Whirlpool, and others. Thus the Encryption Service 201 provides encryption as a service in the architecture 10 and enables a myriad of applications to have access to the latest supported encryption algorithms and can be updated with subsequent releases as they become available.

The Communications and P2P Services 202 provide secure P2P communications. Communications and P2P Services 202 may use, in some embodiments, Triple DES (data encryption standard) (3DES) to establish a secure encrypted communications path to and between any devices connected via the darQvpn 100. While 3DES is discussed in this example, other encryption systems may be implemented as well. Once secure P2P communication has been established, this secure data channel can be used for text, chat, file sharing, interactive voice and video, or to provide other services. While some commercially available P2P systems require devices on both sides of the communication to run matching applications, the Communications and P2P Services 202 provides for interoperability between various applications built on the darQframe API 300. For example, one user device might be running one application using a particular encryption scheme and be in communication, such as via text, with another device running a different texting application with a different encryption scheme. The architecture 10 and the darQframe API 300 enable the various applications and encryption schemes to be abstracted, eliminating the necessity for devices to operate the same applications, encryption schemes, and so on.

The Authorization Service 203 of the architecture 10 may, in some embodiments, be similar to the standard Central Authentication Service (CAS) protocol. The Authorization Service 203 permits a user to provide their credentials only once to enable access to multiple applications. The Authorization Service 203 also allows for the selection and stacking of multiple authentication methods including, for example but not limited to, standard passwords, personal identification numbers (PINs), two-factor authentication (2FA), three-factor authentication (3FA), n-factor authentication (nFA), and biometrics. Users can connect to the Authentication Service 203 internally or from outside of the LAN/VPN. For example, internal connections are used to ensure authentication and interoperability between applications as well as for authorizing optional darQzone 500 features. Outside connections may be, for example, for the purpose of connecting darQzone 500 enabled devices to the darQvpn 100.

The darQframe API 300 provides application developers access to all the functions and services of the architecture 10. The darQframe API 300 defines how applications interoperate with one another and allows access to internal functions of each of the components, described herein, of the architecture 10. All applications, including for example the internal functions like darQdrive 101 and darQsync 102, are built on the darQframe API 300 to facilitate interoperability between applications and provide the most current and updated algorithms for encryption, data privacy, communications, and so on. The darQframe API 300 may be open to third party developers to design cyber security and other applications. Accordingly the darQframe API 300 defines both the Private API and the Open API.

The darQapps 400 include a number of different software solutions and software applications running on the architecture 10. For example, many of the darQapps 400 may be written in Java and use Java core libraries, as will be readily understood by the skilled artisan. The present disclosure contemplates providing a publicly available system or kit for developing darQapps 400. Software developers will be provided access to the software development kit (SDK) to assist in the development of additional darQapps 400. The SDK will include tools, sample code, and relevant documentation for creating darQapps 400 for cyber security and other applications. Table A below includes a non-exclusive list of exemplary software application (darQapps 401-4##) that might be developed in accordance with the present disclosure.

The darQzone 500 is the graphical user interface (GUI) that may be provided on the user device or user equipment that enables access to and functioning of applications and services related to the architecture 10. darQzone 500 is the gateway to the darQvpn 100 and the control and management panel for all cyber security protocols. Primarily a framework overlay, darQzone 500 would be installed before any darQapp 400 or other applications or services can be accessed, downloaded or installed. The darQzone 500 would provide for user verification and authentication in order to access the darQzone 500 and other systems of the architecture 10. Other features of the darQzone 500 may be icons or other tools to enable the user to readily identify and assist the user in operation of the services, such as accessing data stored on the darQdrive 101 of the architecture 10. The darQzone 500 provides access to and combines the functionality of: VPN via darQvpn 100, file encryption and data backup and recovery via darQdrive 101, Ghost Drive110, and Encryption Service 201. The darQzone 500 also enables a P2P communications channel for text, voice and video, and so on between darQzone 500 users via darQvpn 100 and Communications and P2P Services 202.

The darQpc 501 is a fully functional personal computer (PC), one PC for each user that is executing the architecture 10 on that user's device or user equipment. The darQpc 501 is, in some embodiments, a personal computer hosted individually and accessible via a network, such as the internet, or in other embodiments may be a single board computer, configured in a server or rack configuration with numerous (any number is contemplated by the present disclosure) other single board computers, each associated with a different individual user of the architecture 10. The darQpc 501 may run Windows 10, Linux, iOS or other operating systems and each of the numerous darQpcs 501 is accessible via the individual user's user equipment operating the architecture 10 via the darQzone 500 GUI and darQvpn 100. Similar to the Ghost Drive 110, darQpc 501 remains offline in an encrypted state when it is not in use. When the user desires to connect to the darQpc 501, the darQpc 501 unencrypts and makes itself available as a fully functional PC on which users can install and run programs, store data and perform communications tasks, and other operations. The functionality of the architecture 10 ensures that these user activities are not attributable to the user, as will be further described herein. When the darQpc 501 is closed or shuts down, such as according to predefined rules, the darQpc 501 encrypts itself and remains available. For example, when the darQpc 501 is closed or shut-down, the darQpc 501 encrypts itself and remains available but is suspended in ‘sleep’ mode. When in ‘sleep’ mode, the darQpc 501 can only be ‘woken’ by the user via the darQzone 500 GUI associated device that requested the ‘sleep’ state. Any attempt to access or wake the darQpc 501 by any other device is ignored. The darQpc 501 functions as a personal computer that is never connected to the public internet in a conventional manner.

Typical virtual machines provide software that only provides the standard operating system environment and leaves security up to the user. The darQpc 501 is accessible only through the darQvpn 100 which includes access to an encrypted cloud by user devices and user equipment via the darQzone 500 GUI. The darQpc 501 is, in some embodiments, fully encrypted and accessible only by the respective user making it truly private. Since it is fully encrypted, and although the darQpc 501 may be provided in a server bank, hosted environment, the darQpc 501 remains encrypted and so its data remains inaccessible even if the hosting server's security might be compromised, whether by an internal or external attempt.

The darQzero 555 is one embodiment of the darQpc 501. In other embodiments a user may employ both a darqQpc 501 and darQzero 555 in coordination to achieve additional functionality. In the present embodiment, the darQzero 555 is an exemplary case of the darQpc 501 but in which the user takes ownership and physical possession of the hardware and hosts or connects to the internet in whatever manner preferred by the user, for example at the user's home or place of business. Thus the darQzero 555 is stand-alone system that remains outside of hosted facilities, that are for example contemplated with regard to the hardware architecture of the darQpc 501 described above, and connects to the user equipment running the darQvpn 100 via darQzone 500. The darQzero 555 provides a higher level of security and provides the user control over the placement of and access to the physical machine.

In some embodiments, the present system provides other advantages, such as providing a ‘software only’ solution for the secure storage of systems and technology, such as, but not limited to, Bitcoin and other cryptocurrencies. It has been suggested that cryptocurrency be managed by paper wallets or hardware wallets as a safe method for storing digital currency. However, paper wallets and hardware wallets have a single point of failure and can be lost, damaged, or stolen. In contrast, the Ghost Drive 110, for example, provides fault tolerant storage that ensures more secure and redundant access to cryptocurrency wallets or files. Further, in some embodiments, owner-defined recovery protocols may be specified to ensure the maximum level of privacy and security while allowing protocols and procedures for self-restoration of wallet files and private keys.

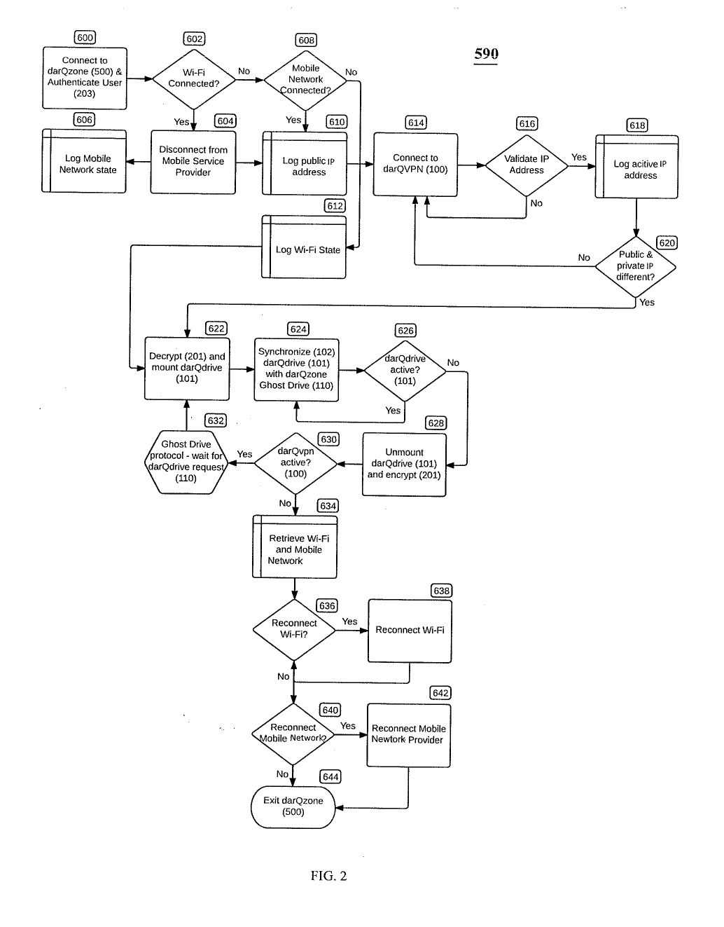

FIG. 2 is a flow chart of a method 590 for securing communications and data according to an embodiment of the disclosure. At block 600, a user launches and logs into the darQzone 500 GUI and uses authorization service 203 to authenticate the user by, for example, user name, password and/or any other pre-defined method, such as 2FA.

At block 602, one or more components of the architecture 10 include logic to determine whether the user equipment running the darQzone 500 is connected to a public or other Wi-Fi network.

At block 604, one or more components of the architecture 10 include logic to determine that if the user equipment is connected to the mobile network and is in an active state then to disconnect the user equipment from the mobile network. In some embodiments where the mobile network connection is the only network connection, the connection may be maintained and alternatively used for the following step in the flow chart shown in FIG. 2.

At block 606, one or more components of the architecture 10 include logic to write the mobile network state to a darQzone 500 application log file.

At block 608, one or more components of the architecture 10 include logic to determine whether the user equipment is connected to a mobile network, such as a cellular network.

At block 610, if the Wi-Fi connection is active, write the Wi-Fi public or other internet protocol (IP) address to the darQzone 500 log file.

At block 612, the Wi-Fi network state, such as active or inactive, is written to the darQzone 500 log file.

At block 614, a secure connection is established between the user equipment and a server or other central or decentralized system via the darQvpn 100 and a new IP address is assigned to the user equipment or user device.

At block 616, one or more components of the architecture 10 include logic to verify the connection between the user equipment and a server or other central or decentralized system via the darQvpn 100 and certify the IP address is in valid range. For example, a valid range would include a table lookup against all valid IP addresses that could be assigned by the darQvpn 100. Such verification checks on the VPN connection ensure the user's IP address has not been compromised, i.e., hijacked or spoofed. If the range is invalid, the process returns to block 614 where logic is provided to retry the connection a certain number of times, which may be perhaps a predetermined number or with changed variables. In one embodiment, the logic is provided to ensure that no connection is made if the IP address is something other than expected.

At block 618, one or more components of the architecture 10 include logic to write the darQvpn 100 IP address to darQzone 500 log file.

At block 620, one or more components of the architecture 10 includes logic to verify that the logged darQvpn 100 IP address and public IP address are different. If the IP addresses are different, then the process continues to block 622, otherwise the process returns to block 614.

At block 622, the Encryption Service 201 decrypts the darQdrive 101 including decrypting the volume image and mounting the file system.

At block 624, the darQsync 102 enables the Ghost Drive 110 and synchronizes with the local darQdrive 101 on the user equipment via the darQvpn 100 such that the Ghost Drive 110 represents a cloud hosted drive mirror image of the darQdrive101 and its data. The Ghost Drive 110 monitors the darQdrive 101 for any changes. As soon as any change to the darQdrive 101 is detected, the Ghost Drive 110 manages and/or communicates with the darQsync 102 function to synchronize all local and cloud hosted mirror data.

At block 626, one or more components of the architecture 10 include logic to determine whether the darQdrive 101 is active based on user requests or has a time-out parameter that has expired. Where the darQdrive 101 is active, return to block 624.

At block 628, where the darQdrive 101 is no longer active or has timed-out, which may be based on user or other system parameters, the darQdrive 101 file system drive is unmounted and the Encryption Service 201 encrypts the volume image of the darQdrive 101. For example where the darQdrive 101 includes 2 gigbytes (GB) of storage, when darQzone 500 is not running, the darQdrive 101 appears as a 2 GB encrypted file. Thus if the darQzone 500 is not running, the encrypted file comprising the 2 GB of data stored on the darQdrive 101 would be practically unrecoverable.

At block 630, one or more components of the architecture 10 include logic to verify where an active connection to the darQvpn 100 exists based on user activity and time rules, which may be based on user or other system parameters. Thus if the conditions are not safe, for example, where the user has logged off or timed out of darQvpn 100, the darQdrive 101 goes from a ‘sleep’ (ready) state, to a truly offline state. Once offline, the user is required to go back through the full authentication process (i.e., username/password) to bring it back to an online state. Examples of safe conditions are: an active authenticated connection via darQvpn 100, no data connection/communication with any outside devices, such as where the user device or user equipment is in airplane mode. If the darQvpn 100 is not active, the darQzone 500 log files are queried to determine the initial mobile network and Wi-Fi states. If both the mobile network and Wi-Fi states were disabled on initiation, the darQvpn 100 state is ignored and the process continues to block 632.

At block 632, if the darQvpn 100 connection is active, suspend the Ghost Drive 110 in wait state. If the darQdrive 101 service is requested, return to block 622.

At block 634, if the darQvpn 100 connection is not active, retrieve mobile network and Wi-Fi network states from the darQzone 500 application log file.

At block 636, the Wi-Fi state that was logged when the darQzone 500 was started is determined.

At block 638, if the Wi-Fi recorded log state was ‘active’ then the user equipment is reconnected to local Wi-Fi.

At block 640, the mobile network state that was logged when the darQzone 500 was started is determined.

At block 642, if mobile network recorded log state was ‘active’ then reconnect the user equipment to the mobile network.

At block 644, the darQzone 500 application exits and all related services are closed.

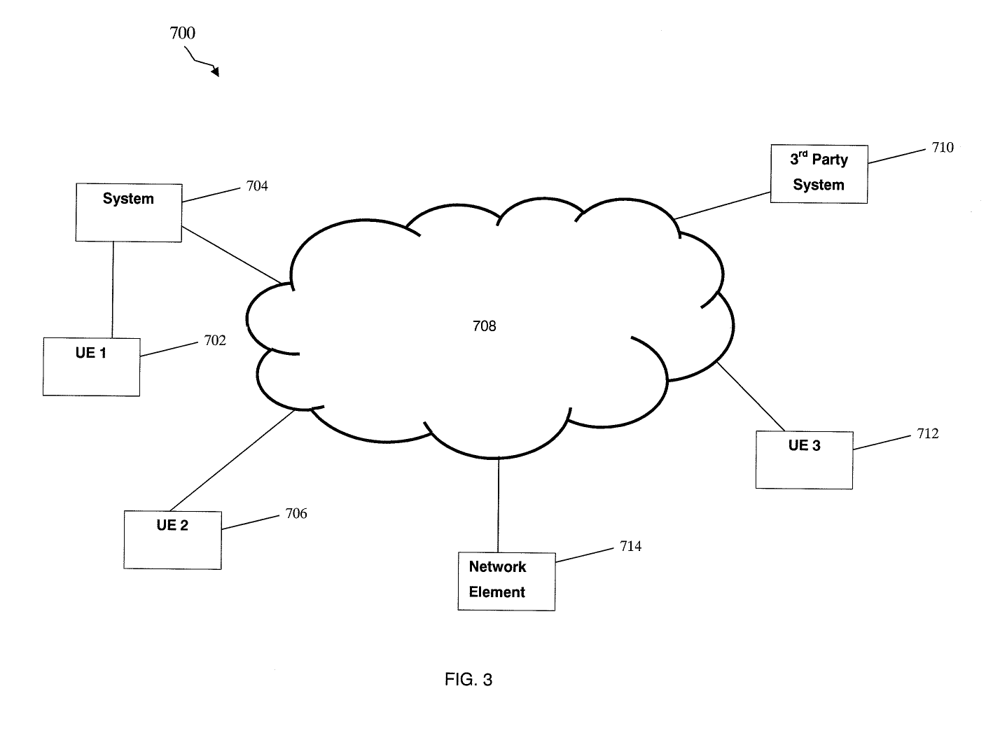

FIG. 3 illustrates a system 700 for securing communications and data according to an embodiment of the disclosure. The system 700 includes user equipment (UE) 1 702, UE 2 706, UE 3 712, a system 704, such as a UE or network element, implementing the darQzero 555 implementation of the present disclosure, a network element 714, and a third party system 710. The various devices illustrated in system 700 may be connected via one or more networks, including but not limited to, the internet 708.

The UEs 702, 706, 712, network element 714, and system 704 implement all or various components of the architecture 10 shown in FIG. 1. In some embodiments when the user of UE 2 706 desires to engage in secure communication, data transfer, and so on, the user launches the darQzone 500 GUI, logs in via the interface, and establishes a secure connection, via darQvpn 100, to the network element 714. The network element 714 may include the VPN systems and component elements to setup and tear-down the VPNs described herein between network element 714 and other systems, as well as between systems such as UE 2 706 and UE 3 712 for communications such as P2P communications.

UE 2 706 may implement the various methods and tasks including accessing the darQdrive 101, which may be resident on the UE 2 706 and redundantly stored on the network element 714, or on other devices in communication with the system 700. Furthermore, the UE 2 706 may access the Ghost Drive 110 which may be resident on the network element 714 or on other devices, such as cloud storage devices, in communication with the system 700. In this manner, UE 2 706 and network element 714 may implement the method substantially as described with reference to FIG. 2.

Further, while network element 714 is illustrated as a single system, it should be understood that, in some embodiments, network element 714 may be a cloud-based service existing and implemented in various systems existing and located as disparate systems in or about the system 700. The network element 714 may include multiple servers, such as for example, racks or blade servers housing single board PCs as previously discussed, such that each PC, such as darQpc 501 is accessible by respective individual users implementing the present architecture 10.

Network element 714 may further include data stores, libraries, and administration and maintenance sub-systems. Network element 714 may also include capabilities to update and maintain the operation and synchronization of the architecture 10 on the various systems, and remotely provide client components and support on the various systems such as UE 1 702, UE 2 706, UE 3 712, and system 704, for example.

In other embodiments, when the user of UE 1 702 desires to implement various aspects of the architecture 10 for secure communication, data access, or otherwise, the UE 1 702 may connect, via the darQzone 500 GUI, to the system 704 which implements the darQzero 555 system to enable communication, data access, or otherwise, directly, in some embodiments, via the network element 714 to enable such secure communications. As such, the system 704 which implements the darQzero 555 may directly enable all the features of the architecture 10, such as but not limited to, synchronization of the darQdrive 101, Ghost Drive 110, P2P communication, and so on, with or without the support services of network element 714.

In practice, implementing the darQapps 400, such as darQtxt 401, from UE 2 706 might be accomplished, in some embodiments, by the user of UE 2 706 accessing, via the darQzone 500 GUI, such an application. The darQvpn 100 would promote communications with network element 714, which in this embodiment coordinates and manages aspects of VPN establishment. Where UE 2 706 wishes to communicate via text message to UE 3 712, the network element 714 would promote establishing a P2P communication between UE 2 706 and UE 3 712. While there might be a period where some of the initial communications between UE 2 706 and UE 3 712 flow through network element 714, once the P2P communication is established, no communications would pass through network element 714 and UE 2 706 and UE 3 712 would communicate directly over a secure VPN connection with the additional benefit, in some embodiments, of encrypted security provided by Encryption Service 201.

In other embodiments, the UE 2 706 may implement, via the functionality provided by architecture 10, the secure P2P texting (or other secure application functionality) with only tangential or no support from the network element 714. In this embodiment, the UE 2 706 and UE 3 712 my communicate securely by implementation of the darQzone 500 GUI and VPN established via darQvpn100 on both UE 2 706 and UE 3 712 with functionality provided by the Communications P2P Service 202, as well as other services, such as the Encryption Service 201, for example.

The UE 2 706 may establish secure communications with other systems, such as third party system 710. Third party system 710 may be the users banking institutions computer system or other system where the user wishes to communicate securely. In this case if the user of UE 2 706 desires to engage in secure communication, data transfer, and so on, the user launches the darQzone 500 GUI, logs in via the interface, and establishes a secure connection, via darQvpn 100, to the network element 714. The network element 714 may include the VPN systems and component elements to setup and tear-down the VPN described herein between network element 714 and other systems as well as between systems such as the UE 2 706 and third party system 710 for communications. The architecture 10 provided herein enables secure communication between the UE 2 706 and third party system 710 by implementing a method similar to that described in FIG. 2.

In another embodiment, UE 2 706 establishes a secure socket layer (SSL) connection from a darQzone 500 enabled device to the darQvpn 100. The darQvpn 100 uses the credentials from the initial SSL session to create a new SSL connection from the darQvpn 100 to the third party system 710. This creates a multi-point, double blind SSL pathway through the darQvpn 100 which authenticates the user to the third party system 710 and separates the user's true origin point from all network traffic to the third party system 710.

TABLE A

| DARQAPPS | PERSONAL PRIVACY & PRODUCTIVITY |
|---|---|
| DARQDRIVE | VIRTUAL ENCRYPTED DRIVE HOSTED IN ENCRYPTED DARQCLOUD |
| DARQALARM | NOTIFICATION UTILITY TO MONITOR AND REPORT ANY ACTIVITY ASSOCIATE |
| | WITH ACCESSING ANY USER DARQZONE OR DARQPC APPS OR |
| | RESOURCES. |
| DARQKEY | ORGANIZE AND ENCRYPT PASSWORDS - AUTOMATICALLY GENERATE |
| | SECURE AND MANGE UNIQUE SECURE PASSWORDS FOR ALL USER ONLINE |
| | SERVICES AND ACCOUNTS |
| DARQNOTES | SECURE NOTES FOR DATA SUCH AS BANK ACCOUNT NUMBERS, PASSPORT |
| | NUMBER, PIN NUMBERS, PASS PHRASES, SAFE COMBINATIONS OR ANY |
| | OTHER TEXT NOTES THAT THE USER DESIRES TO SECURE |
| DARQPIX | ORGANIZE AND ENCRYPTED PHOTOS - ENSURES PRIVACY BY SCANNING |
| | TEMPORARY FILES TO MAKE SURE THE DARQPIX COPY IS THE ONLY COPY. |
| DARQCRYPT | ENCRYPTED FOR FILE LOCKER FOR DESIGNATED FILES STORED ON USER |
| | DEVICE - INCLUDES COMPLETE FILE MANAGEMENT APPLICATION WITH |
| | RULES AND ‘TIME LOCKS’ |
| DARQSCAN | A STEP BEYOND ANTIVIRUS - SCANS DEVICE FOR INTRUSION |
| | VULNERABILITIES- OPEN SOCKETS, ZOMBIE WEB SERVERS AND OTHER |
| | POTENTIAL HAZARDS |
| DARQSHRED | COMPLETELY ERASE FILES FROM MEDIA BLEACH-BIT STYLE |
| DARQBOMB | SELF-DESTRUCT UTILITY THAT CAN QUICKLY DESTROY DESIGNATED FILES |
| | OR ERASE EVERYTHING AND RENDER THE DEVICE USELESS. RULE BASED |
| | AND REMOTE EXECUTION OF PREDEFINED TASKS TO KEEP USER DATA |
| | FROM INTRUSTION |
| | PEER-TO-PEER COMMUNICATIONS BETWEEN DARQZONE USERS |
| DARQTXT | PRIVATE ENCRYPTED TEXTING - NO LOGGING |
| DARQCHAT | PRIVATE ENCRYPTED TEXT, VOICE AND VIDEO CHAT - NO LOGGING |
| DARQBOX | ADDS FILE SHARING CAPABILITIES TO USER DARQDRIVE |

OTHER APPS AND SERVICES:

| | |
|---|---|
| DARQMAIL | SECURE ENCRYPTED EMAIL |
| DARQPHONE | SECURE P2P ENCRYPTED VOICE CALLING |
| DARQVOICE | ENCRYPTED STORAGE AND MANGEMENT OF ALL USER VOICEMAILS |
| DARQBOOK | ANONYMOUS P2P ‘FACEBOOK’ FOR THE DARQZONE COMMUNITY |
| DARQSPOT | SECURE WIFI FOR COMMERCIAL BUSINESSES AND COFFEE SHOPS |
| DARQWEB | HOSTING OF FULL WEBSITES THAT ARE ONLY ACCESSIBLE THROUGH |
| | DARQZONE. |
| DARQNAS | HOSTED ENCRYPTED DATA STORAGE - RAID 1 (MIRROR) OR RAID 5 |
| | (PARITY) |
| DARQCLOUD | VIRTUAL DATA STORAGE FOR LARGE VOLUME OR OFFSITE BUSINESS DATA |
| DARQLAN | TURNS ANY LOCAL AREA NETWORK (LAN) INTO A DARQZONE |
| DARQZERO | OTHER TBD DARQ BRANDED HARDWARE AND SOFTWARE FOR RETAIL DELIVERY |

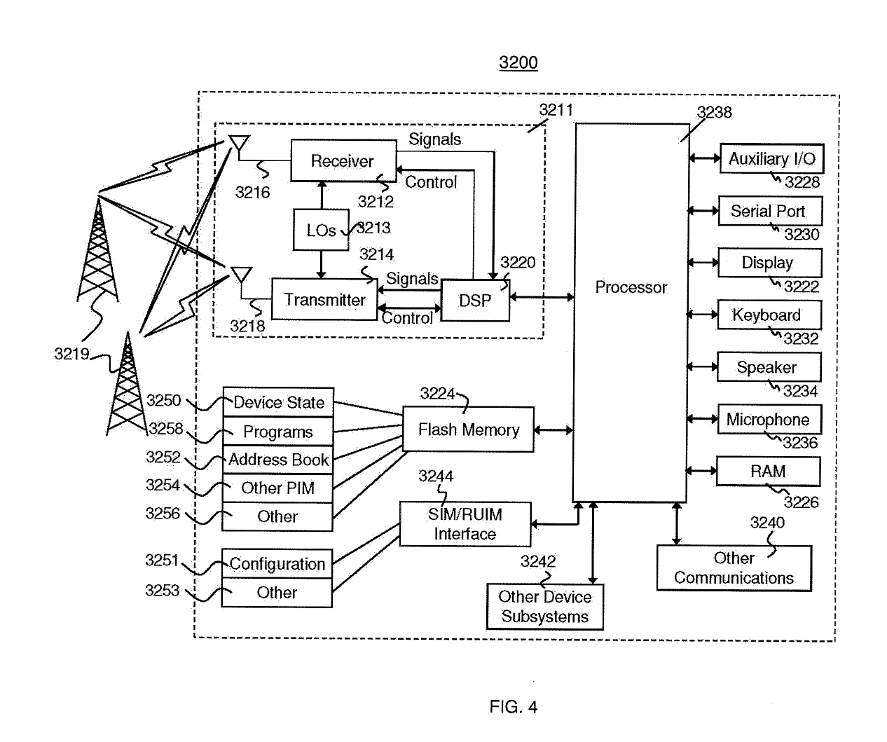

Further, the various methods or operations described herein may be implemented by a communications device (e.g., user equipment (UE) devices such as 702, 706, 712, system 704, third party system 710, and network element 714, etc.). An example of a communications device is described below with regard to FIG. 4. The communications device 3200 may comprise a two-way wireless communication device having voice and data communication capabilities. In some embodiments, voice communication capabilities are optional. The communications device 3200 generally has the capability to communicate with other computer systems on the Internet. Depending on the exact functionality provided, the communications device 3200 may be referred to as a data messaging device, a two-way pager, a wireless e-mail device, a cellular telephone with data messaging capabilities, a wireless Internet appliance, a wireless device, a smart phone, a mobile device, or a data communication device, as examples.

Where the communications device 3200 is enabled for two-way communication, it may incorporate a communication subsystem 3211, including a receiver 3212 and a transmitter 3214, as well as associated components such as one or more antenna elements 3216 and 3218, local oscillators (LOs) 3213, and a processing module such as a digital signal processor (DSP) 3220. The particular design of the communication subsystem 3211 may be dependent upon the communication network 3219 in which the communications device 3200 is intended to operate.

Network access may also vary depending upon the type of network 3219. In some networks, network access is associated with a subscriber or user of the communications device 3200. The communications device 3200 may use a removable user identity module (RUIM) or a subscriber identity module (SIM) card in order to operate on a network. The SIM/RUIM interface 3244 is typically similar to a card slot into which a SIM/RUIM card may be inserted. The SIM/RUIM card may have memory and may hold many key configurations 3251 and other information 3253, such as identification and subscriber-related information.

When network registration or activation procedures have been completed, the communications device 3200 may send and receive communication signals over the network 3219. As illustrated, the network 3219 may comprise multiple base stations communicating with the communications device 3200.

Signals received by antenna 3216 through communication network 3219 are input to receiver 3212, which may perform such common receiver functions as signal amplification, frequency down conversion, filtering, channel selection, and the like. Analog to digital (A/D) conversion of a received signal allows more complex communication functions, such as demodulation and decoding to be performed in the DSP 3220. In a similar manner, signals to be transmitted are processed, including modulation and encoding for example, by DSP 3220 and are input to transmitter 3214 for digital to analog (D/A) conversion, frequency up conversion, filtering, amplification, and transmission over the communication network 3219 via antenna 3218. DSP 3220 not only processes communication signals but also provides for receiver and transmitter control. For example, the gains applied to communication signals in receiver 3212 and transmitter 3214 may be adaptively controlled through automatic gain control algorithms implemented in DSP 3220.

The communications device 3200 generally includes a processor 3238 which controls the overall operation of the device. Communication functions, including data and voice communications, are performed through communication subsystem 3211 in cooperation with the processor 3238. Processor 3238 also interacts with further device subsystems such as the display 3222, flash memory 3224, random access memory (RAM) 3226, auxiliary input/output (I/O) subsystems 3228, serial port 3230, one or more user interfaces such as keyboards or keypads 3232, speaker 3234, microphone 3236, other communication subsystem 3240 such as a short-range communications subsystem, and any other device subsystems generally designated as 3242. Serial port 3230 may include a universal serial bus (USB) port or other port currently known or developed in the future.

Some of the illustrated subsystems perform communication-related functions, whereas other subsystems may provide “resident” or on-device functions. Notably, some subsystems, such as keyboard 3232 and display 3222, for example, may be used for both communication-related functions, such as entering a text message for transmission over a communication network, and device-resident functions, such as a calculator or task list.

Operating system software used by the processor 3238 may be stored in a persistent store such as flash memory 3224, which may instead be a read-only memory (ROM) or similar storage element (not shown). The operating system, specific device applications, or parts thereof, may be temporarily loaded into a volatile memory such as RAM 3226. Received communication signals may also be stored in RAM 3226.

As shown, flash memory 3224 may be constituted by different areas for both computer programs 3258 and program data storage 3250, 3252, 3254 and 3256. These different storage types indicate that each program may allocate a portion of flash memory 3224 for their own data storage use. Processor 3238, in addition to its operating system functions, may enable execution of software applications on the communications device 3200. A predetermined set of applications that control basic operations, including at least data and voice communication applications for example, may typically be installed on the communications device 3200 during manufacturing. Other applications may be installed subsequently or dynamically.

Applications and software may be stored on any computer-readable storage medium. The computer-readable storage medium may be tangible or in a transitory/non-transitory medium such as optical (e.g., CD, DVD, etc.), magnetic (e.g., tape), or other memory currently known or developed in the future.

One software application may be a personal information manager (PIM) application having the ability to organize and manage data items relating to the user of the communications device 3200 such as, but not limited to, e-mail, calendar events, voice mails, appointments, and task items. One or more memory stores may be available on the communications device 3200 to facilitate storage of PIM data items. Such a PIM application may have the ability to send and receive data items via the wireless network 3219. Further applications may also be loaded onto the communications device 3200 through the network 3219, an auxiliary I/O subsystem 3228, serial port 3230, short-range communications subsystem 3240, or any other suitable subsystem 3242, and installed by a user in the RAM 3226 or a non-volatile store (not shown) for execution by the processor 3238. Such flexibility in application installation may increase the functionality of the communications device 3200 and may provide enhanced on-device functions, communication-related functions, or both. For example, secure communication applications may enable electronic commerce functions and other such financial transactions to be performed using the communications device 3200.

In a data communication mode, a received signal such as a text message or web page download may be processed by the communication subsystem 3211 and input to the processor 3238, which may further process the received signal for output to the display 3222, or alternatively to an auxiliary I/O device 3228.

A user of the communications device 3200 may also compose data items, such as email messages for example, using the keyboard 3232, which may be a physical or on-screen/virtual complete alphanumeric keyboard or telephone-type keypad, among others, in conjunction with the display 3222 and possibly an auxiliary I/O device 3228. Such composed items may then be transmitted over a network 3219 through the communication subsystem 3211.

For voice communications, overall operation of the communications device 3200 is similar, except that received signals may typically be output to a speaker 3234 and signals for transmission may be generated by a microphone 3236. Alternative voice or audio I/O subsystems, such as a voice message recording subsystem, may also be implemented on the communications device 3200. Although voice or audio signal output may be accomplished primarily through the speaker 3234, display 3222 may also be used to provide an indication of the identity of a calling party, the duration of a voice call, or other voice call-related information, for example.

Serial port 3230 may be implemented in a personal digital assistant (PDA)-type device for which synchronization with a user's desktop computer (not shown) may be desirable, but such a port is an optional device component. Such a serial port 3230 may enable a user to set preferences through an external device or software application and may extend the capabilities of the communications device 3200 by providing for information or software downloads to the communications device 3200 other than through a wireless network 3219. The alternate download path may, for example, be used to load an encryption key onto the communications device 3200 through a direct and thus reliable and trusted connection to thereby enable secure device communication. Serial port 3230 may further be used to connect the device to a computer to act as a modem.

Other communications subsystems 3240, such as a short-range communications subsystem, are further optional components which may provide for communication between the communications device 3200 and different systems or devices, which need not necessarily be similar devices. For example, the subsystem 3240 may include an infrared device and associated circuits and components or a Bluetooth™ communication module to provide for communication with similarly enabled systems and devices. Subsystem 3240 may further include non-cellular communications such as WiFi, WiMAX, near field communication (NFC), and/or radio frequency identification (RFID). The other communications element 3240 may also be used to communicate with auxiliary devices such as tablet displays, keyboards or projectors.

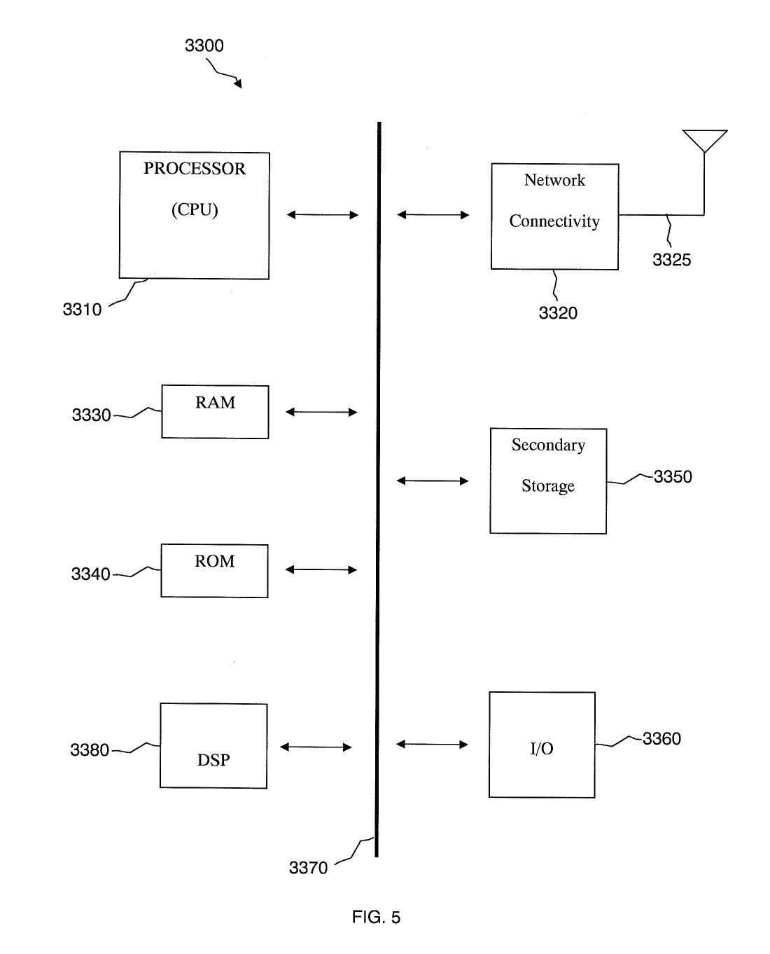

The communications device 3200 and other components described above might include a processing component that is capable of executing computer readable instructions or logic related to the actions described above. FIG. 5 illustrates an example of a system 3300 that includes a processing component 3310 suitable for implementing one or more embodiments disclosed herein. In addition to the processor 3310 (which may be referred to as a central processor unit or CPU), the system 3300 might include network connectivity devices 3320, RAM 3330, ROM 3340, secondary storage 3350, and I/O devices 3360. These components might communicate with one another via a bus 3370. In some cases, some of these components may not be present or may be combined in various combinations with one another or with other components not shown. These components might be located in a single physical entity or in more than one physical entity. Any actions described herein as being taken by the processor 3310 might be taken by the processor 3310 alone or by the processor 3310 in conjunction with one or more components shown or not shown in the drawing, such as a DSP 3380. Although the DSP 3380 is shown as a separate component, the DSP 3380 might be incorporated into the processor 3310.

The processor 3310 executes instructions, codes, computer programs, or scripts that it might access from the network connectivity devices 3320, RAM 3330, ROM 3340, or secondary storage 3350 (which might include various disk-based systems such as hard disk, floppy disk, or optical disk). While only one CPU 3310 is shown, multiple processors may be present. Thus, while instructions may be discussed as being executed by a processor, the instructions may be executed simultaneously, serially, or otherwise by one or multiple processors. The processor 3310 may be implemented as one or more CPU chips.

The network connectivity devices 3320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as CDMA devices, GSM radio transceiver devices, universal mobile telecommunications system (UMTS) radio transceiver devices, long term evolution (LTE) radio transceiver devices, new generation radio transceiver devices, worldwide interoperability for microwave access (WiMAX) devices, and/or other well-known devices for connecting to networks. These network connectivity devices 3320 may enable the processor 3310 to communicate with the Internet or one or more telecommunications networks or other networks from which the processor 3310 might receive information or to which the processor 3310 might output information. The network connectivity devices 3320 might also include one or more transceiver components 3325 capable of transmitting and/or receiving data wirelessly.

The RAM 3330 might be used to store volatile data and perhaps to store instructions that are executed by the processor 3310. The ROM 3340 is a non-volatile memory device that typically has a smaller memory capacity than the memory capacity of the secondary storage 3350. ROM 3340 might be used to store instructions and perhaps data that are read during execution of the instructions. Access to both RAM 3330 and ROM 3340 is typically faster than to secondary storage 3350. The secondary storage 3350 is typically comprised of one or more disk drives or tape drives and might be used for non-volatile storage of data or as an over-flow data storage device if RAM 3330 is not large enough to hold all working data. Secondary storage 3350 may be used to store programs that are loaded into RAM 3330 when such programs are selected for execution.

The I/O devices 3360 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 3325 might be considered to be a component of the I/O devices 3360 instead of or in addition to being a component of the network connectivity devices 3320.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the scope disclosed herein.

What is claimed is:

1. A system for secure data and communications, comprising:
a processor;
a data storage device;
a first component configured to create a virtual private network (VPN) connection with one or more other devices;
a second component configured to synchronize data stored on the data storage device with data stored remotely; and
a graphical user interface (GUI) in communication with the data storage device, the first component, and the second component, the GUI configured, responsive to user input or instructions stored on the storage device, to instruct the first component to create a virtual private network connection with one or more other devices, and further configured to instruct the second component to synchronize data stored on the data storage device with data stored remotely.
